(19) United States
(12) Patent Application Publication
(10) Pub. No.: US 2020/0189562 A1
(43) Pub. Date: Jun. 18, 2020

(54) METHOD FOR INFLUENCING THE ENERGY CONSUMPTION OF A MOTOR

(71) Applicant: CPK Automotive GMBH & Co. KG, Munster (DE)

(72) Inventor: Frank Noack, Ennigerloh (DE)

(21) Appl. No.: 16/795,636

(22) Filed: Feb. 20, 2020

Related U.S. Application Data
(63) Continuation of application No. PCT/EP2018/072491, filed on Aug. 21, 2018.

(30) Foreign Application Priority Data
Aug. 23, 2017 (DE) 102017119291.3

(51) Int. Cl. B60W 20/10; B60K 35/00; B60L 15/20; B60W 10/06; B60W 10/08; B60W 50/14

(52) U.S. Cl. CPC B60W 20/10; B60K 35/00; B60L 15/2045; B60W 10/06; B60W 10/08; B60W 50/14; B60W 2520/105; B60K 2370/174; B60L 2240/26; B60L 2240/14; B60W 2050/146; B60W 2530/10; B60K 2370/167

(57) ABSTRACT

A method for influencing the energy consumption during the operation of a motor, particularly a motor in a vehicle, to reduce the total amount of energy consumed. A setpoint value that is based on a parameter that correlates with the energy consumed by the motor is defined. The parameter can be distance consumption, for example, mpg or liter/100 km, or some other parameter that correlates with the energy consumed. The actual value of the parameter is calculated during operation of the motor and compared with the setpoint value. Energy consumption is reduced if the actual value exceeds the setpoint. The method allows some flexibility in defining how frequently or when a reduction in the energy consumption is effected, in order to accommodate particular operating or driving conditions or driving behavior. One example of the variation is a consumption credit that possibly allows an overrun of the setpoint value.

### BACKGROUND INFORMATION

### Field of the Invention

The invention relates to a method for reducing energy consumption in electric motors and internal combustion engines for vehicles and also for stationary engines or motors.

### Discussion of the Prior Art

US 20160096527 A1 discloses a conventional method using model predictive control for planning a route to be driven in a vehicle. The route to be travelled is known, as are disturbance factors on the route, such as, for example, topographical gradients. Given these known factors, the engine torque can be influenced anticipatorily, so as to maintain the lowest possible fuel consumption by the engine.

DE 102015005043 A1 discloses a method for determining the gas consumption of a gas-operated engine. Target operating conditions are known, but the engine operates under actual operating conditions and the actual gas consumption of the engine is detected. A target gas consumption of the engine is calculated, depending on the measured actual gas consumption and on deviations between actual operating conditions and target operating conditions.

DE 102015217538 A1 discloses a method for determining a setpoint transmission ratio of a motor vehicle, as well as a computer program that can be used for this purpose. Shift recommendations are displayed to the driver of the motor vehicle, to encourage selecting the optimum transmission ratio. Deviations between the recommended setpoint gear and the gear actually used by the driver can be output as a time-cumulative value, in particular in the form of a symbolic graphic.

A method known in the automotive field, yet unrelated to controlling fuel consumption, is the familiar “cruise control” that provides automated speed control. In this method, a specified speed is selected as the target variable and the power of the vehicle engine is automatically influenced in a way that maintains the target speed as constant as possible, even under different weather and topographical conditions. To achieve this end, more or less energy is automatically supplied to the engine.

DE102012204596 A1 also relates to a method for controlling the speed of a motor vehicle. In this method, a setpoint speed is to be maintained, and the actuating angle of the accelerator pedal is taken into account. Depending on external factors, such as slopes or gradients along the route travelled, as well as wind conditions, for example, headwinds or tailwinds acting on the vehicle, it is possible that deviations from the setpoint speed can occur, even though the specific accelerator position remains constant. In order to not exceed certain consumption limit values, it is possible to deviate from the setpoint speed that is supposed to be maintained.

Automotive practice teaches another known method that is applied in a speed limiter, also called a speed governor. With this method, a maximum speed is selected as the target variable and the power of a vehicle motor is automatically regulated, so that the vehicle does not exceed the maximum speed. Irrespective of other control commands from the driver, for example, independently of the position of the accelerator pedal, the energy supplied to the motor is automatically limited in this method, so that the vehicle does not exceed the maximum speed as long as the “limiter” is activated.

The consumption of a motor vehicle, more precisely, the consumption of the motor that powers the vehicle, is typically determined as a distance consumption. With internal combustion motors, which operate with liquid fuel, this distance consumption is typically given in Europe as number of liters per 100 km of distance travelled (liter/100 km), and in the US as the number of miles that can be travelled with one gallon of fuel (mpg). Despite the technical innovations of recent years, the actual distance consumption, particularly in passenger cars, has not gone down significantly. In the past 20 years, certain exhaust gas values have been reduced by more than 90%, whereas, in the same time period, the average distance consumption has decreased by less than 17%. Additional weight due to equipment for safety and comfort, vehicle-buying trends, such as the increasing percentage of passenger vehicles that are SUVs, with their comparatively greater vehicle weight and their greater air resistance, as well as emotional aspects that influence driving behavior, all encourage a trend of new vehicles having bigger, more powerful engines, which allow the operator to engage in perhaps less than economical driving behavior. Although specific performance and consumption values are constantly being further optimized, there has been no apparent significant reduction in absolute consumption values, i.e., in the actual, measurable distance consumption values.

What is needed, therefore, is a method that contributes to a reduction in energy consumption of motors, and particularly, of motor vehicles. What is further needed is such a method that encourages motor vehicle drivers to engage in driving behavior that results in more economical fuel consumption.

### BRIEF SUMMARY OF THE INVENTION

It is an object of the invention to provide a method that enhances an particularly economical operation of a motor by regulating the amount of energy that is supplied to the motor and, in particular, generally limiting consumption to a setpoint consumption value. More particularly, it is a goal to improve energy consumption values in passenger vehicles and to encourage energy-saving driving behavior.

The method is described with reference to its use in motor vehicles, but is not limited to this type of use. Rather, the method may also be implemented in other types of motors such as, for example, stationary motors and motors used for other purposes than driving. It is noted here that the term “motor” is used throughout. This term encompasses electric motors, hybrid motors, internal combustion engines, etc. The term consumption refers to energy consumed by a vehicle or a motor, the energy being in the form of fuel, such as diesel, gasoline, or LPG, as well as electrical energy.

Very briefly and in its most basic form, the energy consumption control method defines a maximum permissible distance consumption (in mpg or liter/km), calculates the actual distance consumption when the motor is operating, compares this actual distance consumption with the maximum permissible distance consumption, and, if necessary, reduces the fuel supplied to the motor sufficiently to maintain the maximum permissible distance consumption.

The concept underlying the method is similar to the well-known diet concept in Germany of FdH (“Friß die Hälfte”), i.e., “eat half”. This concept is easy for people to understand and is undisputed in its effectiveness. The concept is similarly applicable to influencing energy consumption. As mentioned above, energy consumption is perceived to be much too high these days and the slogan “TdH” (“Tank die Hälfte”), i.e., “tank half,” signals to people that the goal of the method is to achieve significant economical and ecological benefits. It is also a positive aspect of the method that those benefits will be noticeable very quickly. As used here, the abbreviation “TH” specifies just one type of target variable (fuel for a motor vehicle) and indicates that the method endeavors to make a significant contribution to reduction in vehicle consumption and emissions.

Competition in the commercial vehicle sector already provides a strong incentive to operate vehicles as efficiently as possible. Although the method according to the invention is applicable to all kinds of motors, it aims particularly to achieve considerable savings in consumption with regard to passenger vehicles, and for this reason, the method has been developed to be particularly suitable for use in passenger vehicles.

Implementation of the consumption control method is based on three considerations: First, that it is technologically possible to specify a meaningful distance consumption value for a vehicle, whereby this distance consumption value is set lower than the average distance consumption that is customary in the field of such vehicles. Second, that the vehicles are equipped with devices that enable the calculation of the instantaneous energy usage, i.e., the actual distance consumption calculated over a time or distance interval while the motor is in operation. And third, that vehicles have devices which enable automatic control over the supply of energy to the motor, such as, for example, electronic motor control, fuel injection, electronic accelerator pedal, etc.

The hardware requirements for carrying out the consumption control method according to the invention already exist in the majority of vehicles, and particularly in newer passenger vehicles, which allows the method to be retroactively set up with a minimal outlay on installation and costs. It may be possible to program the existing control system in a vehicle to execute the method, in other words, an update may be provided to achieve this. If that is not possible, then a separate control device may be installed, one that has, for example, an operator control element that allows the operator to selectively activate/deactivate the program for influencing the energy consumption of the motor.

The first step of the method is to define a setpoint value for the distance consumption. The second is to calculate the instantaneous moving average of actual distance consumption. Intermediate steps of this step include, for example, calculating an actual distance consumption from the amount of fuel injected over a certain period of time in conjunction with the distance travelled during this period of time and repeating this calculation continuously or with high frequency at low time intervals, to obtain the moving average.

Once the setpoint is defined and a program is running that calculates the actual distance consumption, the method compares the calculated actual distance consumption with the setpoint distance consumption. If the calculated actual distance consumption is greater than the setpoint distance consumption, an automatic control reduces the energy supply to the motor until, in the next or in a subsequent re-calculation of the actual distance consumption, the new actual value is equal to or less than the setpoint value. In other words, the method automatically intervenes in the mode of operation of the motor selected by the driver or the vehicle. If the calculated actual distance consumption does not exceed the specified setpoint distance consumption, the method according to the invention does not exert any influence on the supply of energy to the motor, i.e., the automatic control does not intervene and the driver can continue driving the vehicle in the accustomed manner.

This very basic configuration of the method according to the invention is a strict application of the automatic control of the supply of energy. There are many situations and conditions that can occur in driving a vehicle that make greater flexibility over the control of the energy supply reasonable and desirable. For that reason, the method according to the invention allows a number of modifications to the program that provide the flexibility needed in certain types of driving situations.

A first variation is the calculation of a consumption credit. The calculated actual distance consumption value is integrated into a calculation for a consumption credit. Periods of travel in which the actual distance consumption is below the setpoint distance consumption accrue as a consumption credit, which then allows the vehicle to exceed the setpoint distance consumption up to the amount of the credit without reducing the energy being supplied to the motor. Such energy overruns are subtracted from the consumption credit and are only allowed as long as the credit has not been exhausted. Thus, for example, lower consumption in comparison with the setpoint distance consumption during downhill travel results in a consumption credit, which may then be used up during a subsequent uphill climb. This ability to accrue and then use up a credit avoids severe dips in speed when driving over mountainous or hilly terrain.

In vehicles with a hybrid drive system, the amount of electrical energy recovered during braking may also accrue to a consumption credit, so that, in a later driving situation, the instantaneous total consumption of fuel and electrical energy is allowed to rise above a defined setpoint distance consumption without incurring an intervention that reduces the supply of energy to the motor or to the combination of combustion and electric motors.

A further variation of the method according to the invention also allows for an override or pause of the automatic control over the supply of energy. Some emergency situations require that the vehicle be able to accelerate rapidly, for example, to remove the vehicle from a danger zone. In such cases, the override allows the driver to exceed the setpoint distance consumption for a short period of time, without an intervention that would slow the vehicle down.

The method further provides the vehicle operator the flexibility to selectively activate or deactivate the control system that controls the supply of energy, whereby the entire program that runs the method may be switched off or just the electronic control that controls the automatic intervention in the supply of energy to the motor. It may be desirable to deactivate the control over the supply of energy when driving over specific terrain or topographies, or for certain occasions. Vacation travel provides a good example of when it may be reasonable to switch off the method. Often, when going on a vacation trip, the vehicle is so loaded down with gear and supplies, that the permissible total weight of the vehicle is nearly or completely reached. A trailer or a roof rack may further add to the increase in the normal distance consumption because of increased air friction. In this situation, it is foreseeable that the automatic control would intervene frequently in the supply of energy to the motor, thereby reducing the speed of the vehicle significantly. Unacceptably low vehicle speed, particularly on steep inclines, may endanger traffic and for this reason, it is reasonable to switch off the automatic control.

A time limit may be set for the deactivation, after which the control is automatically activated. This time limit, for a few minutes or a few hours, or until the next motor start, avoids inadvertently leaving the control switched off for longer than necessary, which would possibly result in unnecessarily high distance consumptions.

Defining the setpoint value for the automatic control of the supply of energy may be based on different parameters. The one discussed above is distance consumption. One way of defining a vehicle specific distance consumption setpoint value is to base the value on the weight of the vehicle. The actual weight or the empty weight of the vehicle, which is indicated in the vehicle documentation, may be used, for example, as a basis to determine the setpoint distance consumption, because generally accepted values for distance consumption per 100 kg of weight are known. In order to reduce fuel consumption, the suggested setpoint value for distance consumption is a value that is one third below the value calculated per vehicle weight. Thus, for a vehicle weighing 1,200 kg with a rule-of-thumb value of 6 liter/100 km, the setpoint value for distance consumption is set at 4 liter/100 km. The slogan “tank half” mentioned above refers to a long-term goal of reduction in consumption by half, to be achieved in the future. The one-third saving suggested here is purely by way of example and represents a practical, initial step toward the goal of reducing consumption by one half. This one-third saving achieves a significant reduction in consumption right away and, importantly, is achievable with the technology that is currently available in almost all vehicles.

A suitable means for carrying out the method according to the invention is an electronic control device that connects to a control system. The method then runs as a program in this electronic control system. The control device has connectors that allow the device to be connected to the electronic motor control that is installed in the vehicle. When used in vehicles, connectors of this type are preferably constructed as the plug-in connectors that are typically used in vehicles. In this way, such a control device is permanently installed at the factory when the vehicle is produced, but is also able to be retroactively installed in existing vehicles.

The concept of reducing energy consumption while operating a motor requires defining a target variable that either represents the energy consumption of the motor or correlates somehow with the energy consumption and setting that target variable as the setpoint value. In a motor vehicle, it is possible to directly detect the fuel consumed by the motor. Thus, for example, in the case of an internal combustion engine, the fuel consumption is recorded in a weight unit such as grams or kilograms, or in a volumetric unit such as liters or gallons, by means of a flow meter or the like.

It is also possible, that the energy consumption be indirectly detected. There are a number of parameters that correlate with fuel consumption. For example, for a specific configuration of an internal combustion engine, the energy consumed by the engine can be precisely calculated, based on detected amounts of one or more of particular components in the exhaust gas. It is known in the automotive field, how to calculate the fuel consumption of an engine, based on the CO₂ emissions. Accordingly, certain emission values of an engine or motor may serve as a suitable target variable for energy consumption, as long as the target variable correlates with the energy consumption of the engine. Examples of such emission values also include the amount of heat emitted by an electric motor, particulate matter in emissions, the exhaust gas emission value of an internal combustion engine, or the like. Thus, the method according to the invention is also applicable in such cases, in which the primary goal is not a desired reduction in energy consumption, but rather, a reduction in some other parameter, such as, for example, certain emissions. As long as the selected parameter correlates with the energy consumption of the motor, application of the method using a setpoint value that is based on an emission value also automatically results in a reduction in the energy consumption of the motor.

Driver behavior and choices made by the driver also have significant influences on consumption, quite apart from the effects that vehicle design has on the vehicle's distance consumption. It is, thus, desirable that a separate or external display be provided in a way that allows the driver or motor operator to see the setpoint value. Some of the choices that are made by the motor operator and that influence energy consumption are as follows:
When choosing which vehicle to buy, the driver not only has a choice between different vehicle models, but usually also choices of different motorizations in the same vehicle model, and particularly, choices relating to different energy efficiency values and/or different consumption behavior.
The weight of the vehicle is, for example, not only determined by the empty vehicle weight, but also by additional loading, and the driver improve distance consumption by removing any unnecessary weight from the vehicle.
The driver can also influence air and rolling friction by removing unnecessary extras that increase such friction, such as, for example, luggage carriers, and by maintaining correct air pressure in the tires.
The driver can monitor the operation of auxiliary units such as air-conditioning, electric motors, and the like, and use them as little as possible and only when needed.
When driving, the driving behavior of the driver can save energy, by avoiding “steep ramps” when accelerating and braking, i.e., jack-rabbit starts and fast, hard braking.
The driver can also keep the distance consumption, as well as the travel time, as low as possible by avoiding driving at rush hour, if it is not necessary to do a planned drive at those critical times.

These areas of driver influence have been known for years. Using the method according to the invention not only provides a way of reducing energy consumption by assigning to some extent automatic control over the supply of energy to a programmable control system, but also allows the driver to see and to directly experience the effects of economical vehicle operation.

Requiring by law use of an energy control method according to the invention would not only help drivers to learn better, i.e., more economical, driving behavior, but would have a long-term positive influence on vehicle design and development, because, then, automotive engineering would not only take into account the consumption that is specific to the motor, but also the actual total consumption of the vehicle, with the result that the engineering would presumably strive to produce vehicles with an increased “total vehicle efficiency” that would include the additional energy consumption due to air friction, due to additional systems, such as electric motors and air-conditioning, as well as ways of recovering energy, for example, when braking. Regulations governing emission pollution control limits for automobiles are in widespread use, with required compliance with ever tighter pollution control limits that are introduced in several stages. Similarly, new passenger vehicles may be required to be equipped with the motor control systems and possibly other control devices that allow the method according to the invention to exert influence over the energy supply to the motor.

Whether or not the consumption control method is made obligatory, it is also foreseeable that the use of the method in inefficient vehicles, with its automatic interventions, will result in frequently throttling of the supply of energy. One positive result of these frequent interventions is that inefficient vehicle concepts, for example, using or acquiring vehicles with consumption-intensive motors or high air resistance, will become significantly less attractive, because such vehicles will be perceived to be unattractive, i.e., slow or sluggish, due to the high frequency of automatic intervention.

Another positive result of implementing the method in passenger vehicles is that energy-efficient vehicle concepts, such as buying or using vehicles with more energy-efficient motors or more aerodynamic designs, improved driving behavior, such as avoiding jack-rabbit starts and sudden braking, etc., will result in less frequent interventions in the supply of power to the motor, and consequently, the more energy-efficient vehicles may end up traveling at higher speeds than the less energy-efficient vehicles.

### DETAILED DESCRIPTION OF THE INVENTION

The invention is a method of influencing the amount of energy consumed when operating a motor, with the goal of reducing the overall amount of energy consumed by a motor or a vehicle powered by the motor, be the motor an internal combustion engine, an electric motor, a hybrid motor, or a liquid propane gas motor used in a motor vehicle, or one of these types of motors used in stationary motor-powered equipment or in a motor used for other purposes. For the sake of brevity, the method according to the invention will be referred to hereinafter as a consumption control method.

Implementation of the consumption control method requires a programmable control system. It may be possible to program an existing control system of a vehicle to carry out the method or a separate control device may be installed.

The consumption control method first specifies a setpoint value against which actual detected values are compared. Detection of the actual value and comparison with the setpoint value is repeated cyclically. An automatic control regulates the energy that is supplied to the motor, based on the comparison, so as to maintain that specified setpoint value. Thus, for example, if the calculated actual value is greater than the setpoint value, the automatic control intervenes and reduces the amount of energy that is supplied to the motor. If the calculated actual value is less than the setpoint value, no intervention in the supply of energy to the motor occurs. In this way, the method maintains the energy consumption as closely as possible to the setpoint value.

The example used to illustrate the method is that of a motor vehicle and the setpoint value is a distance consumption value, i.e., a specified amount of fuel or electric energy consumed over a certain distance. Other parameters may also be used as the setpoint value and those options will be discussed below.

The setpoint value for distance consumption may be specified in a number of ways. One way is to base the setpoint value on the weight of the vehicle. A reasonable assumption for the distance consumption of a vehicle with an internal combustion engine, based on the high octane gasolines and diesel fuels that are commonly used today, is a distance consumption of 0.5 liter/100 km of fuel per 100 kg of vehicle weight, whereby this number is based on the empty vehicle weight cited in the vehicle documentation. Thus, for a vehicle weighing 1,200 kg, the average distance consumption is 6 liter/100 km in normal use. For a desired reduction of one-third, the suggested setpoint value for distance consumption is, thus, 4 liter/100 km.

Adding weight to a vehicle increases overall consumption, so it may be preferable, given the particular loading of a vehicle, to base the setpoint value for distance consumption on the instantaneous weight, i.e., current actual weight of the vehicle. Literature suggests increased consumption values of 0.3 to 0.5 liter/100 km for every 100 kg of additional weight. Applying the increased consumption value of 0.3 liter/100 km and the targeted one-third reduction in consumption, as an example, the increase in the setpoint value for distance consumption is 0.2 liter/100 km per 100 kg of extra weight. Thus, for a vehicle weighing 1,200 kg and carrying 500 kg of extra weight, the increase in the distance consumption value is estimated to be 5×0.2 liter/100 km, so that, in this case, the suggested setpoint value for distance consumption is set at 5 liter/100 km.

The instantaneous weight of the vehicle may be also be calculated automatically by a comparison of the “desired torque” and the actual acceleration. The data necessary for this calculation for modern passenger vehicles are indicated on the Controller Area Network bus (CAN bus). The position of the accelerator pedal or the throttle valve of a vehicle is used as an indicator of the torque desired by the driver.

The setpoint value for distance consumption may also be adjusted for driving resistances that are not vehicle-specific and over which the driver has no control. Factors, such as hilly or mountainous terrain, and weather conditions, such as rain or wind, frequently result in changes in either increases or decreases in the distance consumption. The method allows the setpoint value be adjusted to accommodate such factors. For example, sensing technology may be used to detect non-vehicle-specific driving resistances and to incorporate the values for these factors into the calculation of the setpoint value. The necessary sensing technology is already available in passenger vehicles, for example, temperature and rain sensors, but it is also possible to use one or more separate sensing devices, for example, an inclination sensor. The adjusted setpoint value is preferably continuously updated—that is to say, re-calculated at sufficiently frequent time intervals—thereby allowing such weather or topographical factors to be factored into the calculation.

The setpoint value for distance consumption may also be adapted to account for vehicle-specific technologies that result in increased consumption. Engines consume more fuel when running cold and also when the vehicle is driven in extremely low outdoor temperatures or at high altitudes. Sensors already exist to detect temperature, engine and ambient, and altitude. Thus, it is possible to detect these conditions and incorporate a correction into the calculation of the setpoint value, and, again, this correction is preferably done quasi-continuously, i.e., at sufficiently small time intervals, so that changes in these conditions are detected with as little delay as possible.

Alternatively, the calculation for the setpoint value for distance consumption may be simplified and, instead of determining the actual weight of the vehicle before or during each drive, the permissible total weight of the vehicle is simply used as a basis for calculating the setpoint distance consumption. In this case, the setpoint value for distance consumption is defined as the sum of the calculated value for the empty weight of the vehicle plus the additional calculated value to accommodate additional weight up to the permissible total weight.

As mentioned above, parameters other than distance consumption may serve as the setpoint value. In internal combustion engines, for example, a reduction in fuel consumption also results in a reduction of the CO₂ emissions of the motor, in other words, there is a direct correlation between the amount of energy consumed and the CO₂ emissions in the exhaust. Thus, the CO₂ equivalent of the energy content of the fuel may be used. The correction factors for vehicles operating with different types of fuel are:
Diesel: 2.62 kg CO₂/liter
Gasoline: 2.32 kg CO₂/liter
LPG 1.9 kg CO₂/liter

In addition to CO₂, it is also possible to base the setpoint value for the method on other emission values, such as NOₓ, other gases, or the amount of particulate matter in the exhaust gas.

In the case of fully electric or hybrid vehicles, the distance consumption of the electrical energy is determined for each of the one or the electric drive motors installed in the vehicle, for example, in kWh/100 km.

When the energy reduction method according to the invention is used with motors other than motor vehicles, such as stationary or other motors, the setpoint value is not based on distance consumption, but instead, on consumption per unit of time or on the efficiency in power generation. The setpoint value may be based the amount of fuel consumed in relation to the power output by the motor, or, if the motor powers a generator, the amount of fuel used in relation to the power generated by the generator. The setpoint consumption values determined for these motors is then expressed, for example, in g/kWh.

A first embodiment of the consumption control method provides automatic control of the energy supplied to the motor, based solely on a comparison of the actual energy consumption for the specified distance or period of time with the setpoint value for the chosen parameter, i.e., distance consumption, exhaust values, etc. Unless otherwise programmed, the method specifies a setpoint value that is one-third lower than the known normal consumption of the motor.

The consumption control method according to the invention also allows a certain amount of flexibility in applying the automatic control over the supply of energy to the motor. In a further embodiment of the method, a consumption credit is calculated and made available. In this embodiment, the calculated actual value for energy consumption is integrated into the calculation for the consumption credit. Thus, based on the example of a motor vehicle, the amount of energy saved during periods of travel in which the actual distance consumption is lower than the setpoint value accrues as a consumption credit. This credit allows a currently calculated actual value to exceed the setpoint value for consumption, until the credit has been expended. In other words, the automatic control does not prevent supplying energy to the motor in excess of the setpoint value, as long as there is sufficient credit to cover the excess amount. This ability to accrue and then use up a consumption credit is particularly advantageous when driving on mountain roads, for example, because it helps avoid inconvenient dips in speed on uphill climbs that might unacceptably hinder the flow of traffic.

In vehicles with a hybrid drive system, the amount of electrical energy recovered during braking may also accrue to a consumption credit, so that, in a later driving situation, the instantaneous total consumption of fuel and electrical energy is allowed to rise above a defined setpoint distance consumption without incurring an intervention that reduces the supply of energy to the motor or to the combination of combustion and electric motors.

A further embodiment of the consumption control method provides an override or pause function of the automatic control over the supply of energy to the motor. It may be important for the vehicle to be able accelerate rapidly, perhaps to avoid a dangerous situation. The pause function allows the driver to exceed the setpoint distance consumption for a short period of time without an intervention by the automatic control that would slow the vehicle down. This pause does not cancel the entire program for the consumption control method, but only overrides the automatic control that intervenes in the supply of energy to the motor.

The pause function is preferably initiated in a way that does not require the vehicle operator to have to push a switch or button. Rather, rapidly depressing the accelerator pedal to the floor, i.e., a kick-down, is one suggested way of initiating the pause function. The advantage of using the kick-down is that it is not feasible to operate a vehicle at full throttle, i.e., with the gas pedal pushed to the floor, for any lengthy period of time, so that it is not a realistic assumption that a driver would use the pause function to override automatic interventions in the supply of fuel for any lengthy period of time.

A further embodiment of the consumption control method allows the vehicle driver or operator of the motor to selectively activate or deactivate the program that controls the supply of energy. The entire program may be terminated, for example, by turning off the respective electronic control, or just that part of the program that controls the intervention in the supply of energy to the motor may be interrupted. In this case, it is left to the driver to decide, whether to use or not to use the consumption control method that controls the supply of energy to the motor.

There are driving situations in which it may be desirable to switch off the program or at least the automatic control of energy supply. Driving over mountainous or otherwise difficult terrain may be one such situation, vacation travel another. In situations, in which it is foreseeable that the automatic control will intervene frequently in the supply of energy to the motor and possibly endanger traffic because of unacceptably slow travel of the vehicle, the driver or operator may switch off the control for the energy supply.

The consumption control method allows a time limit to be set on the deactivation, for example, for a few minutes or a few hours, or until the next motor start. The control system activates automatically at the end of the time limit, thereby activating the automatic control again. The time limit avoids inadvertently leaving the automatic control switched off for longer than necessary, resulting in unnecessarily high distance consumptions.

In a yet further embodiment of the consumption control method, the method is used on a voluntary basis, whereby the vehicle operator defines the setpoint value. This embodiment is particularly directed to teaching and encouraging economical driving behavior and allows the driver to specify setpoint values that correspond more closely to the driver's own progress in adapting driving behavior to more economical behavior. Thus, when the driver first begins to use the method, he or she is able to initially set the setpoint value to a relatively high value, one that is just slightly lower than the known average distance consumption for the vehicle, and then to subsequently specify successively lower setpoint values as time goes on. This application of the consumption control method encourages more energy-economical behavior, yet takes into account the fact that the driver is still in the process of improving his or her driving behavior. Frequent automatic interventions are generally perceived as annoying, and one of the goals of the method is to encourage good driving behavior, yet also not tax the patience of the driver by applying automatic interventions that go beyond an acceptable frequency. The ability to define the setpoint value to just a little below the hitherto average distance consumption for the specific driver and vehicle results in less frequent automatic interventions, than if the setpoint were set at the final desired setpoint value. A reduction in consumption also means a direct, equivalent reduction in fuel costs, so that change in driving behavior as a result of using the automatic control over the supply of energy has a direct and positive monetary effect for the vehicle operator.

As mentioned above, the method requires the use of a control device or connection to a control system to run the program to control the flow of energy to the motor, based on the comparison of the setpoint value and the calculated actual value. The control device preferably has calculation means for updating the setpoint value and a display, which allows the setpoint value to be adjusted, based on topographical or weather-related conditions as described above. The setpoint value for a specific motor or for a specific vehicle may be pre-set and this fixed, so-called “nominal setpoint value” displayed for the motor operator to see, while, in reality, correction factors for the above-mentioned influences are being taken into account. These correction factors then permit the nominal setpoint value to be exceeded during operation of the motor. It seems desirable, however, that the displayed setpoint value also be updated as a function of the correction factors, that is to say, that a so-called “sliding setpoint value” be used, and that the instantaneous, actual setpoint value, which may change, depending on driving and/or weather conditions, is also shown on the setpoint display that is visible to the motor operator.

Preferably, the control device has a display that shows the specified setpoint value and also any available consumption credit. In particular, when this display is provided in the field of view of the motor operator, the ability to see the consumption credit provides an incentive for a particularly consumption-optimized driving style.

The control device preferably allows the setpoint value to be changed, based on regulations or specified targets that the driver sets. In particular, a programmable control device is suitable for use in different types motors or vehicles, to allow the setpoint values to be changed in accordance with the respective use or vehicle. Such a programmable device also makes it possible to have large-scale production of the control device. The control device is then installed at the factory in new vehicles, and is also retroactively installable in already existing vehicles and, because it is programmable, able to be adapted for use in essentially any vehicle or with many different types of motors.

The display may be arranged in the housing of the control device, in order, for example, to read out and display the functions or the programming of the control device. Alternatively, the display may be installed at a location remote from the control device, for example, in the field of vision of the driver of a vehicle equipped with the control device, or, when used in a stationary motor, the display may be provided at a location remote from the stationary motor.

It is understood that the embodiments described herein are merely illustrative of the present invention. Variations in the consumption control method in motors may be contemplated by one skilled in the art without limiting the intended scope of the invention herein disclosed and as defined by the following claims.

What is claimed is:

1. A method for reducing energy consumption during the operation of a motor, comprising the following method steps:
a) defining a target variable of a specific parameter as a setpoint value, wherein the specific parameter correlates to the energy consumption of the motor;
b) supplying energy to the motor,
c) calculating an actual value of the specific parameter during operation of the motor;
d) comparing that actual value with the setpoint value;
e) repeating the step of calculating and comparing cyclically;
f) integrating each actual value that is calculated into a calculation for a consumption credit and adding any amount of the actual value that is below the setpoint value to the consumption credit;
g) after each comparison, determining whether the actual value exceeds the setpoint value, and if the actual value exceeds the setpoint value, then deducting an amount of the actual value that is greater than the setpoint value from the consumption credit and, if there is sufficient consumption credit to cover the amount of the actual value, suppressing an automatic reduction of the supply of the energy to the motor; and,
h) if, after each comparison, the consumption credit is zero or insufficient to cover an amount of the actual value that is greater than the setpoint value, then automatically reducing the supply of energy to the motor, so as to bring a subsequent actual value closer to or equal to the setpoint value.

2. The method of claim 1,
wherein the motor drives a motor vehicle and a value for distance consumption of the vehicle is defined as the specific parameter.

3. The method of claim 2, further comprising the step of:
i) determining the setpoint value on the basis of an instantaneous vehicle weight.

4. The method according to claim 3, wherein the step of determining the setpoint value includes the step of:
j) automatically calculating the instantaneous vehicle weight by comparing a desired torque with an actual acceleration of the vehicle.

5. The method of claim 1,
wherein any parameter that correlates with the energy consumption of the motor is definable as the target variable.

6. The method of claim 5,
wherein the motor is an internal combustion engine that exhausts an emission gas and wherein a component of the emission gas is definable as the target variable.

7. The method of claim 1, further comprising the steps of:
k) providing an electronic control system;
l) storing the setpoint value in the electronic control system as a variable that is programmable, such that an initially defined setpoint value is replaceable with another setpoint value.

8. The method of claim 7, further comprising the step of:
m) initiating a pause that suppresses the automatic control over the supply of energy to the motor;
wherein the automatic control is suppressed during the pause, even then, when the actual value exceeds the setpoint value.

9. The method of claim 8, further comprising the step of:
n) setting a time limit for the pause, wherein, at the end of the time limit, the pause is lifted and the automatic control is activated.

10. The method of claim 1, further comprising the step of:
o) defining a power output by the motor in relation to a quantity of energy supplied to the motor as the specific parameter.

11. The method of claim 10, wherein the motor powers an electric generator, the method further comprising the step of:
p) defining power output of the generator in relation to the supply of energy to the motor as the specific parameter.

12. A control device for running a program that controls a supply of energy to a motor, the control device comprising:
an electronic controller; and
connectors that allow the control device to be connected to an electronic motor control.

13. The control device of claim 12, further comprising:
a display for showing a specified setpoint value.

14. The control device of claim 12, further comprising:
a display for showing an available consumption credit.

15. The control device of claim 12, further comprising:
calculation and input means for programming the setpoint value.

16. The control device of claim 12, further comprising:
calculation means for updating the setpoint value.

17. The control device of claim 12, further comprising:
input means for activating a pause in the consumption control method in such a way that, during a pause, a reduction in the supply of energy to the motor is suppressed, even if the actual value exceeds the setpoint value.
